(19) United States
(12) Patent Application Publication
(10) Pub. No.: US 2012/0074699 A1
(43) Pub. Date: Mar. 29, 2012

(54) WIND ENERGY PLANT AND ENERGY TRANSMISSION DEVICE FOR A WIND ENERGY PLANT

(75) Inventors: Volker Kreidler, Hechingen (DE); Rolf-Jürgen Steinigeweg, Herzogenaurach (DE)

(73) Assignees: Winergy AG, Voerde (DE); Siemens Aktiengesellschaft, Muenchen (DE)

(21) Appl. No.: 13/264,550

(22) PCT Filed: Feb. 26, 2010
(86) PCT No.: PCT/EP10/52478

§ 371 Date: Dec. 8, 2011

(30) Foreign Application Priority Data
Apr. 14, 2009 (DE) 10 2009 017 027.8

(51) Int. Cl. H02P 9/04; H01F 38/14; F03D 7/04

(52) U.S. Cl. 290/44; 416/25; 307/104

(57) ABSTRACT

A wind energy plant has a rotor with a rotor hub mounted on a pod and a plurality of rotor blades adjustable by corresponding electrical drives. An electrical generator is connected to the rotor for supplying energy to electrical loads arranged in the rotor hub. A primary part of a rotary transformer arranged concentric to a rotor bearing is connected to the pod and a secondary part of the rotary transformer is arranged in the rotor hub and co-rotates with the rotor hub. A first frequency converter is connected between the primary part and a supply voltage source for generating a high-frequency field voltage from a low-frequency supply voltage, and a second frequency converter is connected between the secondary part and the electrical loads for generating a low-frequency load voltage from a transformed high-frequency field voltage.

Wind energy plants are used for converting kinetic energy of wind into electrical energy by means of a rotor in order to feed said electrical energy into an electrical energy transmission system, for example. Motive energy of a wind flow acts on rotor blades which are mounted on a rotor hub and are set in rotary motion in the event of a wind flow. The rotary motion is transmitted directly or by means of a transmission to a generator, which converts the motive energy into electrical energy. A drive train comprising the generator is arranged in a pod mounted on a tower in conventional wind energy plants.

Rotor blades of wind energy plants have an aerodynamic profile, which brings about a pressure difference which is caused by a difference in the flow rate between the intake and pressure sides of a rotor blade. This pressure difference results in a torque acting on the rotor, said torque influencing the speed of said rotor.

Wind energy plants have predominantly a horizontal axis of rotation. In such wind energy plants, wind direction tracking of the pod generally takes place by means of servomotors. In this case, the pod which is connected to the tower via an azimuth bearing is rotated about the axis thereof.

Rotors with 3 rotor blades have caught on more than single-blade, twin-blade or four-blade rotors since three-blade rotors are easier to manage in terms of oscillations. In the case of rotors with an even number of rotor blades, tipping forces acting on a rotor blade as a result of slipstream effects are reinforced by a rotor blade which is opposite and is offset through 180°, which results in increased demands being placed on the mechanics and material. Rotors with 5 or 7 rotor blades result in aerodynamic states which can be described mathematically in relatively complicated fashion since air flows on the rotor blades influence one another. In addition, such rotors do not enable any increases in performance which are economically viable in terms of their relationship to the increased complexity involved in comparison with rotors with 3 rotor blades.

Wind energy plants often have pitch drive systems for rotor blade adjustment. The flow rate differences between the intake and pressure sides of the rotor blades are altered by the adjustment of the angle of attack of the rotor blades. In turn, this influences the torque acting on the rotor and the rotor speed.

For operation of pitch drive and regulation systems, electrical energy is required which is transmitted from the pod to electrical loads arranged in the rotor hub via sliprings in conventional wind energy plants. Status and control signals for the pitch drive or regulation systems are also often transmitted via the sliprings. Sliprings are subject to mechanical wear and represent a potential source of faults in a wind energy plant which is not inconsiderable.

The present invention is based on the object of providing a wind energy plant whose pitch drive and regulation systems are supplied with energy in a reliable and robust manner with respect to external environmental conditions, and of specifying suitable system components for this purpose.

This object is achieved according to the invention by a wind energy plant having the features specified in claim 1 and by an energy transmission device having the features specified in claim 11. Advantageous developments of the present invention are specified in the dependent claims.

The wind energy plant according to the invention has a rotor which comprises a rotor hub mounted on a pod and a plurality of rotor blades which can be adjusted by means of in each case one electrical drive device. An electrical generator is connected to the rotor. A rotary transformer, which is intended to supply energy to a plurality of electrical loads arranged in the rotor hub, is arranged concentrically with respect to a rotor bearing. A primary part of the rotary transformer is connected to the pod. A secondary part of the rotary transformer is arranged in the rotor hub and is capable of rotating therewith. In addition, the wind energy plant comprises a first frequency converter for generating a high-frequency field voltage from a low-frequency supply voltage, said frequency converter being connected between the primary part and a supply voltage source. Furthermore, a second frequency converter is provided for generating a low-frequency load voltage from a high-frequency, transformed field voltage, said second frequency converter being connected between the secondary part and the electrical loads in the rotor hub.

Instead of a second frequency converter, a rectifier for generating a DC voltage from a high-frequency transformed field voltage can be provided, said rectifier being connected between the secondary part and the electrical loads in the rotor hub. Furthermore, the rotary transformer can be part of a transmission, which connects the rotor to the generator, and can provide a high-frequency AC voltage via an electrical plug-type connection at a rotor-side transmission shaft end.

The wind energy plant according to the invention enables operationally reliable supply of electrical energy to electrical loads arranged in the rotor hub without any maintenance restrictions. This is of particular importance in offshore wind energy plants. The wind energy plant according to the invention is robust with respect to bending torques exerted by wind forces on the rotor and the pod owing to the use of a high-frequency field voltage for the rotary transformer, without any negative effects on a variation in the air gap width between the primary and secondary parts. The rotary transformer furthermore enables transmission of a sufficiently high continuous power for operation of at least 3 pitch drive and regulation systems.

Corresponding to an advantageous development of the present invention, a rotor of the generator is capable of rotating with the rotor hub, and a rotor winding adjoins the secondary part of the rotary transformer. This enables a compact and inexpensive embodiment of a wind energy plant.

Corresponding to a further advantageous configuration, the rotary transformer can be integrated in the rotor bearing, and the rotor bearing can be integrated in a drive-side bearing of a transmission which connects the rotor to the generator. In this way, the rotor, transmission, bearing and rotary transformer can be matched to one another in an efficient manner and a space-saving plant component configuration can be achieved.

Corresponding to a preferred development of the present invention, the high-frequency field voltage has a frequency of over 25 kHz. In this way, noise pollution for humans owing to the operation of a wind energy plant can be reduced.

The present invention will be explained in more detail below using an exemplary embodiment with reference to the drawing, in which:

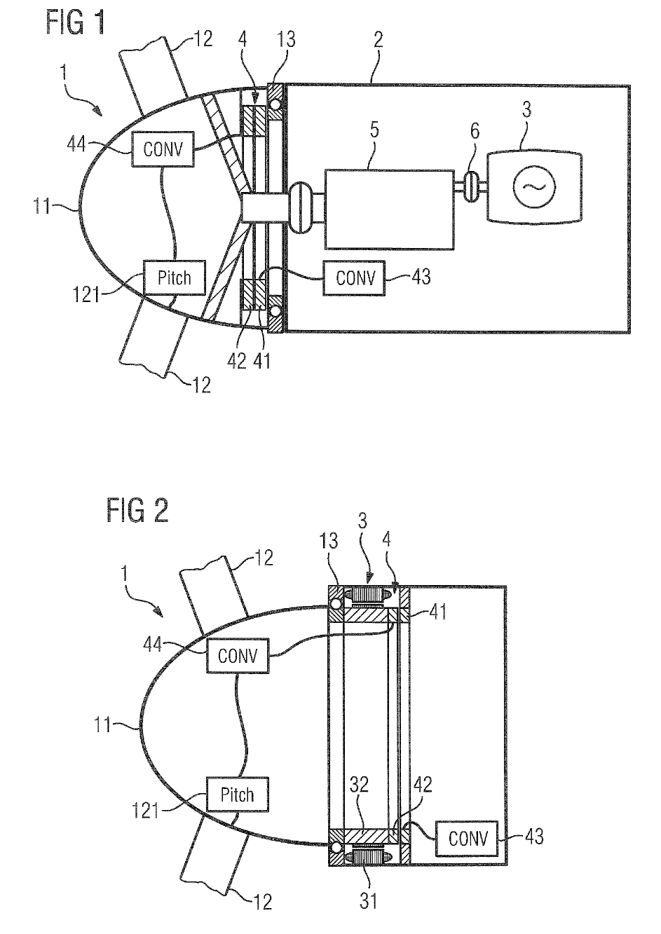

FIG. 1 shows a first variant of a wind energy plant with an energy transmission device according to the invention,

FIG. 2 shows a second variant of a wind energy plant with an energy transmission device according to the invention,

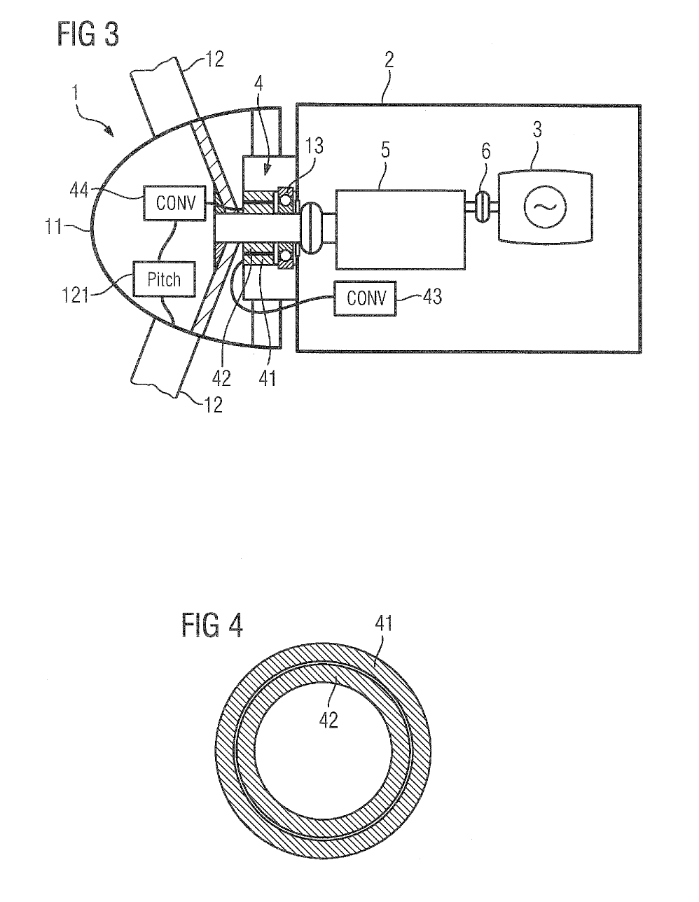

FIG. 3 shows a third variant of a wind energy plant with an energy transmission device according to the invention,

FIG. 4 shows a cross-sectional illustration of a primary and secondary part of a rotary transformer of an energy transmission device as shown in FIG. 3.

The wind energy plant illustrated in FIG. 1 has a rotor 1, which comprises a rotor hub 11 mounted on a pod 2 and a plurality of rotor blades 12, which can each be adjusted by means of a separate pitch system 121. The rotor 1 is connected to an electrical generator 3 via a transmission 5 and a clutch 6.

Furthermore, the wind energy plant illustrated in FIG. 1 has an energy transmission device 4, which comprises a rotary transformer, which is arranged concentrically with respect to a rotor bearing 13, for supplying energy to the pitch system 121 arranged in the rotor hub 11. An annular primary part 41 of the rotary transformer is connected to the pod 2 via the rotor bearing 13. The primary part 41 and the rotor bearing 13 can be combined to form an integrated system component.

In addition, the rotary transformer comprises an annular secondary part 42, which is flange-connected to the rotor hub 11 and is capable of rotating therewith. In order to produce a high-frequency field voltage from a low-frequency supply voltage, a first frequency converter 43 is provided, which is connected between the primary part 43 and a supply voltage source (not explicitly illustrated in FIG. 1). The energy transmission device 4 furthermore comprises a second frequency converter 44 for generating a low-frequency load voltage from a high-frequency transformed field voltage. Instead of a second frequency converter, a rectifier can also be provided for producing a DC voltage. The second frequency converter 44 is connected between the secondary part 42 and the pitch system 121.

The primary part 41 and the secondary part 42 of the rotary transformer of the wind energy plant illustrated in FIG. 1 are arranged so as to be axially spaced apart from one another in separate planes and have substantially the same diameter. An air gap in the rotary transformer, in which a high-frequency electromagnetic field is induced by the field voltage, extends axially between the primary part 41 and the secondary part 42.

Control and status signals from and to the pitch system 121 can also be transmitted via the rotary transformer. As an alternative to this, the control and status signals can also be transmitted via a WLAN connection or a suitable other radio link.

In the wind energy plant illustrated in FIG. 2, in contrast to the wind energy plant illustrated in FIG. 1, a rotor 32 of the generator 3 is capable of rotating with the rotor hub 11 and is integrated in said rotor hub. The rotor bearing 13 of the wind energy plant illustrated in FIG. 2 adjoins a stator 31 of the generator 3. Furthermore, the secondary part 42 of the rotary transformer is arranged adjacent to a rotor winding and concentrically with respect thereto.

The wind energy plant illustrated in FIG. 3 comprises a rotary transformer, whose primary part 41 and secondary part 42, in contrast to the arrangement shown in FIG. 1, are arranged concentrically one inside the other in a common plane (see also FIG. 4). The air gap in the rotary transformer extends radially between the primary part 41 and the secondary part 42, which have different diameters. Advantageously, the rotary transformer and the rotor bearing 13 form an integrated system component.

The application of the present invention is not restricted to the above exemplary embodiments.

What is claimed is:

1.-11. (canceled)

12. A wind energy plant comprising:
a rotor which comprises a rotor hub mounted on a pod and a plurality of rotor blades, each rotor blade connected to an electrical drive device for adjustment of the rotor blade,
an electrical generator connected to the rotor,
a rotary transformer arranged concentrically with respect to a rotor bearing, for supplying energy to a plurality of electrical loads arranged in the rotor hub, wherein a primary part of the rotary transformer is connected to the pod and a secondary part of the rotary transformer arranged in the rotor hub and co-rotating with the rotor hub,
a first frequency converter connected between the primary part and a supply voltage source for generating a high-frequency field voltage from a low-frequency supply voltage, and
a second frequency converter connected between the secondary part and the plurality of electrical loads in the rotor hub for generating a low-frequency load voltage from a transformed high-frequency field voltage.

13. The wind energy plant of claim 12, wherein the electrical generator comprises a generator rotor which co-rotates with the rotor hub.

14. The wind energy plant of claim 13, wherein a winding of the electrical generator rotor adjoins the secondary part of the rotary transformer.

15. The wind energy plant of claim 12, wherein the primary part and the secondary part are arranged concentrically, one inside the other, in a common plane, and wherein an air gap of the rotary transformer extends radially between the primary part and the secondary part.

16. The wind energy plant of claim 12, wherein the primary part and the secondary part are arranged in separate planes with an axial offset, and wherein an air gap of the rotary transformer extends axially between the primary part and the secondary part.

17. The wind energy plant of claim 12, further comprising a rotor bearing, wherein the rotary transformer is integrated in the rotor bearing.

18. The wind energy plant of claim 17, further comprising a transmission connecting the rotor to the electrical generator, wherein the rotor bearing is integrated in a drive-side bearing of the transmission.

19. The wind energy plant of claim 12, wherein the rotor blades are adjusted by a pitch drive system, and wherein the rotary transformer transmits at least one of control and status signals to or from the pitch drive system.

20. The wind energy plant of claim 12, wherein the high-frequency field voltage has a frequency of more than 25 kHz.

21. The wind energy plant of claim 12, wherein the second frequency converter is implemented as a rectifier which generates a DC voltage as the low-frequency load voltage.

22. An energy transmission device for a wind energy plant comprising:
a rotary transformer arranged concentrically with respect to a rotor bearing of the wind energy plant, for supplying energy to a plurality of electrical loads arranged in a rotor hub of the wind energy plant, wherein a primary part of the rotary transformer is connected to a pod and a secondary part of the rotary transformer arranged in the rotor hub and co-rotating with the rotor hub,
a first frequency converter connected between the primary part and a supply voltage source for generating a high-frequency field voltage from a low-frequency supply voltage, and
a second frequency converter connected between the secondary part and the plurality of electrical loads in the rotor hub for generating a low-frequency load voltage from a transformed high-frequency field voltage.
